(19) United States
(12) Patent Application Publication
(10) Pub. No.: US 2011/0173178 A1
(43) Pub. Date: Jul. 14, 2011

(54) METHOD AND SYSTEM FOR OBTAINING SCRIPT RELATED INFORMATION FOR WEBSITE CRAWLING

(76) Inventors: Craig Conboy, Perth (CA); Darcy Steven Chomeyko, Nepean (CA); Derek Lawrence Ross McDougall, Kanata (CA); Constantine Grancharov, Ottawa (CA); Andrew Rolleston, Ottawa (CA); Duncan Smith, Kanata (CA)

(21) Appl. No.: 13/069,773

(22) Filed: Mar. 23, 2011

Related U.S. Application Data
(62) Division of application No. 11/367,752, filed on Mar. 3, 2006.
Application No. 11/367,752 is a continuation-in-part of application No. 10/064,176, filed on Jun. 19, 2002, now Pat. No. 7,496,636.

(51) Int. Cl. G06F 17/30

(52) U.S. Cl. 707/709; 707/E17.108

(57) ABSTRACT

A web crawler system has an automatic website crawler and a virtual browser that provides script related information to the website crawler. The virtual browser transforms an HTML document included in a web page of the website into an XML document, and builds a document object model containing document objects in a tree structure based on the XML document. The virtual browser extracts from the DOM scripts that are potentially executable, and executes the extracted scripts using a browser object model provided for the virtual browser containing objects and methods and properties that are used for script execution so as to capture script related information generated by execution of the scripts.

### RELATED APPLICATIONS

This application is a Continuation-in-Part of U.S. application Ser. No. 10/064,176, filed on Jun. 19, 2002, which is incorporated herein by reference in its entirety.

### FIELD OF THE INVENTION

This invention relates to a method and system for obtaining script related information for the purpose of website crawling.

### BACKGROUND OF THE INVENTION

The World Wide Web available on the Internet provides a variety of specially formatted documents called web pages. The web pages are traditionally formatted in a language called HTML (HyperText Markup Language). Many web pages include links to other web pages which may reside in the same website or in a different website, and allow users to jump from one page to another simply by clicking on the links. The links use Universal Resource Locators (URLs) to jump to other web pages. URLs are the global addresses of web pages and other resources on the World Wide Web.

As web technology evolves, websites become more and more complex. The tendency in website development is to move from using purely static HTML to using HTML and script code to provide enhanced functionality. As a result, it is now common to use script code to construct web page links, i.e., to create URLs dynamically. Often the process of dynamically constructing URLs involves many variables and some rather complex script code. This makes it very difficult to resolve, i.e., extract and obtain, such URLs, when it comes to website crawling.

Website crawling or spidering is a process to automatically scan contents of websites by following links and fetching the web pages. Web crawling agents or “spiders” are software programs for performing the crawling over websites. Typically, existing web crawling agents are used to find specific information of interest in the Web.

Before the introduction of script code into Web pages, crawling agents could parse HTML code for standard URLs. Since all URLs had to be coded to the HTML specification, this task was relatively easy. However, as sites evolved they increasingly relied upon script code to provide more advanced functionality that standard HTML did not allow for. The format of the URLs in the script code varies widely from implementation to implementation. Unlike static HTML, there is no standard that the script code must follow for encoding URLs. Accordingly, script code presents problems for crawling agents that need to parse URLs. There is no longer a common syntax or format for the URLs and thus they are difficult to find consistently.

An existing approach to this problem is to use customizable pattern matching algorithms that statically read through the script code on a page or in a script file, and based on pattern matching try to “guess” what in that script code might be a URL. The pattern matching provides some utility but the use of the pattern matching algorithms has two basic problems: 1) the algorithms invariably miss URLs in the script code and 2) the algorithms do not always extract the entire URL correctly.

Also, existing approaches were directed to resolution of URLs only and did not detect other script related information created by the script code.

It is therefore desirable to provide a new mechanism that can provide more complete script related information during website crawling.

### SUMMARY OF THE INVENTION

It is an object of the invention to provide a novel system and method for obtaining script related information for website crawling.

The present invention transforms HTML documents in web pages into XML documents to obtain information generated by script code.

In accordance with an aspect of the present invention, there is provided a virtual browser for obtaining script related information for website crawling. The virtual browser comprises an HTML transformer, a DOM builder, a script extractor, a BOM provider and a script execution engine. The HTML transformer is provided for transforming an HTML document included in a web page of the website into an XML document. The DOM builder is provided for building a document object model (DOM) based on the XML document. The script extractor is provided for extracting one or more scripts from the DOM. The BOM provider is provided for providing a browser object model (BOM) containing BOM objects and methods that are usable by the scripts for script execution. The script execution engine is provided for executing the scripts extracted by the script extractor using one or more of the objects and methods of the BOM provided by the BOM provider to capture script related information generated by execution of the scripts.

In accordance with another aspect of the invention, there is provided a web crawler system for crawling website. The web crawler system comprises a website crawler for automatically crawling website; and the virtual browser.

In accordance with another aspect of the invention, there is provided a method of obtaining script related information for website crawling. The method comprises the steps of receiving a web page of a website; transforming an HTML document included in the web page into an XML document; building a document object model (DOM) based on the XML document; extracting one or more scripts from the DOM; providing a browser object model (BOM) containing BOM objects and methods that are usable by the scripts for script execution; executing the scripts extracted by the script extractor using one or more of the objects and methods of the BOM; and capturing script related information generated by the execution of the scripts.

In accordance with another aspect of the invention, there is provided a computer readable medium storing instructions or statements for use in the execution in a computer of the method of obtaining script related information for website crawling.

In accordance with another aspect of the invention, there is provided a propagated signal carrier carrying signals containing computer executable instructions that can be read and executed by a computer, the computer executable instructions being used to execute the method of obtaining script related information for website crawling.

Other aspects and features of the present invention will be readily apparent to those skilled in the art from a review of the following detailed description of preferred embodiments in conjunction with the accompanying drawings.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and'numerous embodiments without departing from the scope of the invention.

### BRIEF DESCRIPTION OF THE DRAWINGS

The invention will be further understood from the following description with reference to the drawings in which:

FIG. 1 is a diagram showing an example of websites having script code;

FIG. 2 is a block diagram showing a URL resolution system in accordance with an embodiment of the present invention;

FIG. 3 is a flowchart showing a method for resolving a URL, in accordance with an embodiment of the present invention;

FIG. 4 is a block diagram showing a URL resolution system in accordance with another embodiment of the present invention;

FIG. 5 is a block diagram showing a URL resolution system in accordance with another embodiment of the present invention;

FIG. 6 is a flowchart showing a method for resolving a URL in accordance with another embodiment of the present invention;

FIG. 7 is a flowchart showing a method for resolving a URL in accordance with another embodiment of the present invention;

FIG. 8 is a block diagram showing a URL resolution system in accordance with another embodiment of the present invention;

FIG. 9 is a block diagram showing a URL resolution system in accordance with another embodiment of the present invention;

FIG. 10 is a block diagram showing a URL resolution system in accordance with another embodiment of the present invention;

FIG. 11 is a block diagram showing a URL resolution system in accordance with another embodiment of the present invention;

FIG. 12 is a block diagram showing a web crawler system in accordance with another embodiment of the invention;

FIG. 13 is a block diagram showing a virtual browser in accordance with an embodiment of the invention;

FIG. 14 is a block diagram showing a script extractor;

FIG. 15 is a diagram showing an example of a browser object model; and

FIG. 16 is a flowchart showing the operation of the virtual browser.

### DETAILED DESCRIPTION OF THE PREFERRED EMBODIMENTS

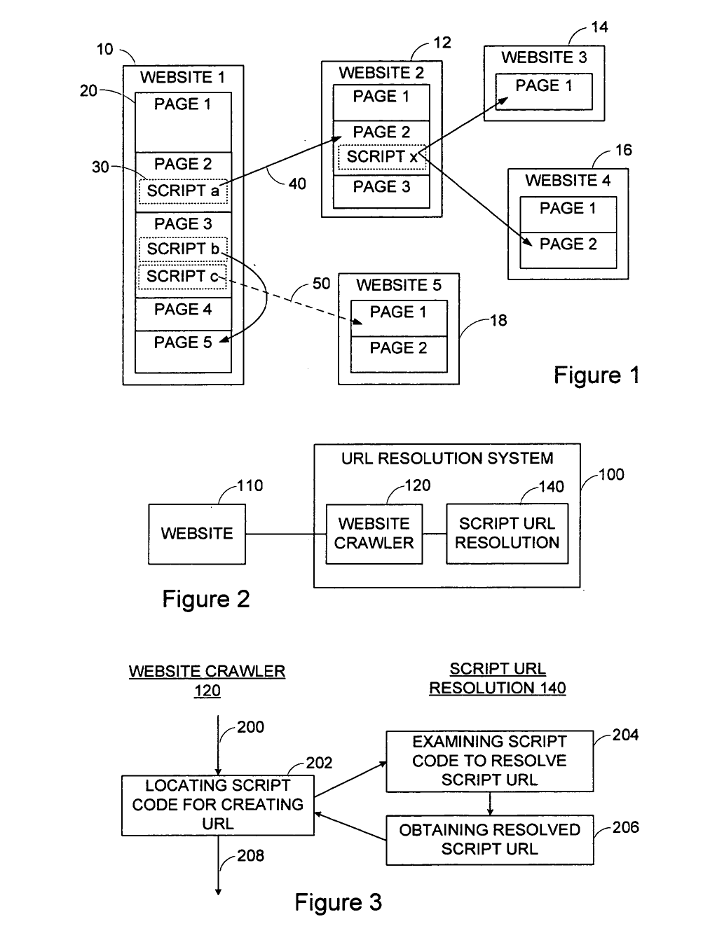

The present invention is suitably used to check the integrity of links in a website. For example, a website 10 shown in FIG. 1 contains web pages or documents 20, some of which have embedded script code 30 which is used to dynamically create URLs. URLs created by the script code are called script URLs hereinafter. Each script URL may designate a local web page located within the same website or a remote web page located in a different website.

For example, in FIG. 1, page 2 of website 1 has script code a which is used to create a script URL identifying page 2 of website 2; page 3 of website 1 has script code b which is used to create a script URL identifying page 5 of website 1, and so on. More than one set of script code may be embedded in a single web page. A single set of script code may create one or more script URLs. The script code typically has a specific part that is used to create one or more script URLs. The entire script code may form the specific part.

Script code for dynamically creating script URLs may be JavaScript, JScript or VBScript and others.

FIG. 1 schematically represents that script code a in page 2 of website 1 can be successfully resolved to create link 40 to page 2 of website 2. However, script code c in page 3 of website 1 cannot be successfully resolved because of an error in the script code or other reasons, and accordingly, the link as represented by broken arrow 50 is unresolvable.

FIG. 2 shows a web crawler system in accordance with an embodiment of the present invention. In this embodiment, the web crawler system is a URL resolution system 100. The URL resolution system 100 comprises a website crawler 120 and a script URL resolution component 140. As shown in FIG. 3, the website crawler 120 scans or crawls website 110 (200). When it encounters or locates script code in the website 110 that is used to dynamically create one or more script URLs (202), the script URL resolution component 140 causes examination of the script code to resolve its script URL or URLs (204). From the examination output, the script URLs are obtained (206). The crawling is continued to locate any other script code that is used to dynamically create one or more URLs (208).

The examination of script code at step 204 may be carried out by explicitly executing the script code. Alternatively, it may be done by examining the script code to obtain the script URLs without explicitly executing the script code. The script URL resolution component 140 may examine the script code or it may use another component to examine the script code, as described below in relation with other embodiments.

Therefore, the URL resolution system 100 allows automatic resolution of script URLs from embedded script code in websites in the context of website crawling, i.e., by locating script code while crawling a website or websites. Since the script code is examined to dynamically obtain the script URLs, complete URLs can be accurately obtained. Unlike the conventional pattern matching which resolve URLs statically, there are minimal possibilities that the URL resolution system 100 will miss script URLs in the website that is being crawled. Thus, the URL resolution system 100 produces accurate results of website crawling.

The URL resolution system 100 may have a function by which users can set the extent of the crawling, as described below.

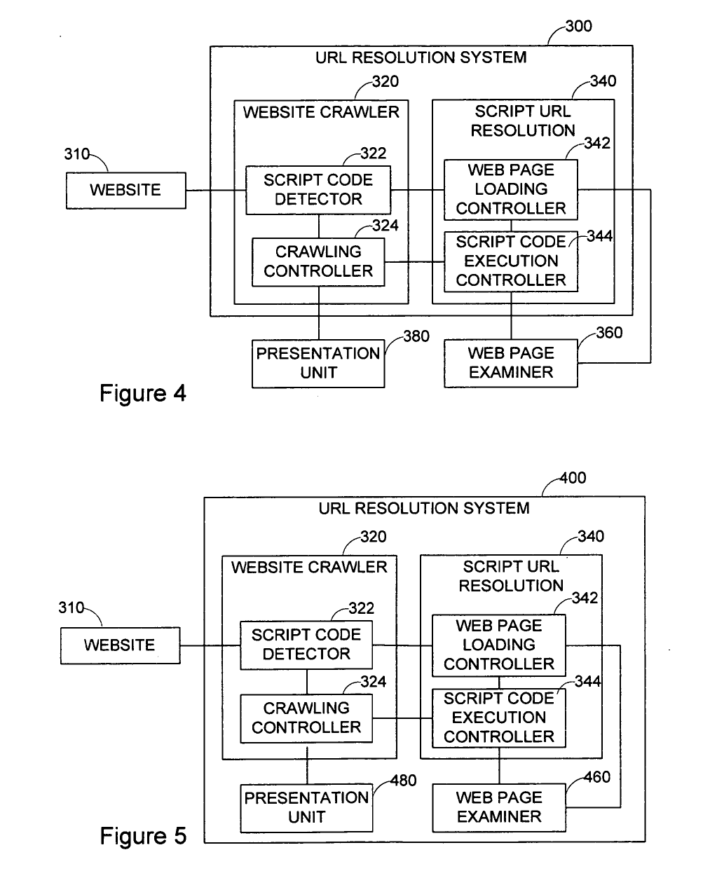

Other embodiments of the present invention are described referring to FIGS. 4 and 5. A URL resolution system 300 shown in FIG. 4 comprises a website crawler 320 and a script URL resolution component 340.

The website crawler 320 has script code detector 322 and crawling controller 324. The crawling controller 324 controls crawling carried out by the website crawler 320. The crawling controller 324 controls the website crawler 320 to crawl individual web pages included in website 310 or other websites to locate web pages that use script code to dynamically create script URLs. The crawling controller 324 receives output of the script URL resolution component 340 and uses the output to control the website crawler 320, as further described below.

To locate web pages that use script code to dynamically create script URLs, the website crawler 320 uses the script code detector 322 to determine if the script code contained in the web page should be executed by determining if it uses a specific part of the script code to dynamically create at least one script URL. The script code detector 322 issues a notification to the script URL resolution component 340 when a web page having such script code is found. The notification includes an identification of the web page.

The script URL resolution component 340 is activated in response to a notification generated by the script code detector 322 of the website crawler 320. The website crawler 320 crawls all web pages on the original website, but it only passes the web pages containing relevant script code to the script URL resolution component 340.

The script URL resolution component 340 controls a web page examiner 360. The web page examiner 360 is a component capable of loading the contents of web pages and executing the entire or a specific part of script code in the loaded web pages. The web page examiner 360 may be a web browser having these functions, or a combination of a web page parser and a script code examiner. The URL resolution system 300 uses an external web page examiner 360. Alternatively, as shown in FIG. 5, an internal web page examiner 460 may be provided within the URL resolution system 400.

The script URL resolution component 340 has a web page loading controller 342 and a script code execution controller 344. The web page loading controller 342 notifies or instructs the web page examiner 360 to load relevant web pages. The script code execution controller 344 instructs the web page examiner 360 to execute specific parts of the script code that will result in dynamically created script URLs. For example, when the script URL resolution component 340 receives a notification from the script code detector 322, the web page loading controller 342 instructs the web page examiner 360 to load the contents of the web page identified in the notification. Then, the script code execution controller 344 executes the script code by interfacing with the web page examiner 360 and using its interface functions to force the execution of the specific parts of the script code in the loaded web pages. The web page examiner 360 captures the script URL(s) resulting from the script code execution and returns these script URLs to the script code execution controller 344. The script code execution controller 344 may instruct the web page examiner 360 to execute the entire script code, rather than only the specific parts thereof.

The script code execution controller 344 outputs the execution results to the website crawler 320. When the execution of the script code is successful, the execution result includes one or more resolved script URLs. When the execution of the script code is unsuccessful, the execution result includes a failure result.

The URL resolution systems 300, 400 may also have a presentation unit 480 or use an external presentation unit 380 to present to users the execution results. The presentation unit 380, 480 may be a user interface, a result log file, an email or other output unit or form. The execution results presented to users may include only the failure results or only resolved script URLs or both. Thus, an administrator of the website may attend to the failures.

Users may also use an input unit (not shown) to initiate or terminate the crawling, or set parameters of the crawling controller 324. For example, the crawling controller 324 may be set such that it crawls a website regularly in a predetermined interval and/or it may start crawling when the website is modified. Also, users may set the extent of the crawling, i.e., users may set the website crawler 320 to crawl only within the original website from which the crawling is initiated, or allow crawling of web pages residing in external websites when web pages in the external websites are linked. In the latter case, it is desirable to limit the extent or depth of the crawling of the external websites. For example, in FIG. 1, the system 100 may allow crawling of only website 1, allow crawling of web pages in secondary website 2 in addition to the originating website 1 only, or further allow crawling of tertiary websites 3 and 4.

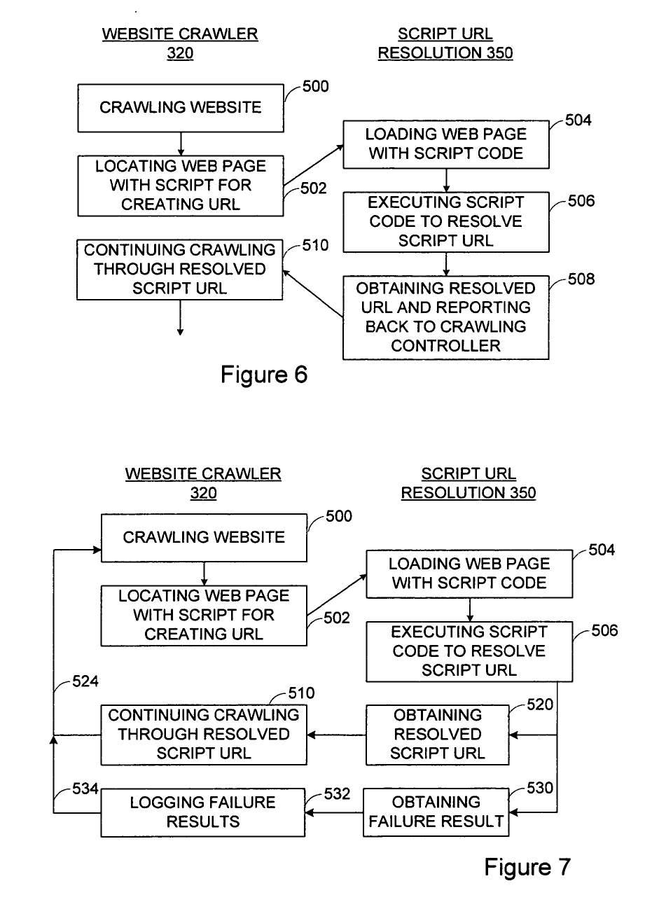

FIG. 6 describes the process of resolving script URLs by script execution in the context of website crawling in accordance with an embodiment of the present invention. The process will be described referring to the URL resolution system 300 shown in FIG. 4. However, different systems, such as system 400 shown in FIG. 5, may also be used.

The website crawler 320 crawls a website 310 (500). Crawling of website 310 may start anywhere in the website 310. During the crawling, the script code detector 322 checks script code embedded in each web page in the website 310 to determine if the web page uses script code to dynamically create one or more script URLs. When the script code detector 322 locates a web page with script code that dynamically creates one or more script URLs (502), the script URL resolution component 340 is activated. The script code detector 322 sends a notification to the script URL resolution component 340 to this end.

In the script URL resolution component 340 the web page loading controller 342 instructs the web page examiner 360 to load the web page with the script code (504). The script code execution controller 344 then instructs the web page examiner 360 to execute the specific interface methods or functions that dynamically execute the script code and create one or more script URLs (506). The script code execution controller 344 may instruct the web page examiner 360 to execute the entire script code or only the relevant portions of the script code. Script URLs are thus resolved by the script code execution. The script code execution controller 344 receives the resolved script URLs from the web page examiner 360, and sends the received script URLs back to the crawling controller 324 (508).

The website crawler 320 continues the crawling (510). It may continue crawling on web pages identified by the resolved script URLs. The website crawler 320 may crawl those web pages immediately when the resolved script URLs are returned, or put them in a queue for crawling at a later time. The website crawler 320 may crawl multiple web pages in parallel.

The process of FIG. 6 represents the case where the links of the script URLs are extracted successfully. However, there may be situations where errors are encountered while executing the script code. FIG. 7 depicts the process that occurs when the website crawler 320 encounters errors while executing the script code.

The steps of crawling a website (500) to executing script code (506) are similar to those shown in FIG. 6. When the execution of the script code is successful, at least one script URL is resolved and obtained (520). The resolved script URL is reported back to the website crawler 320. In the website crawler 320, the crawling controller 324 controls the website crawler 320 to continue crawling the web page identified by the resolved script URL (510). The crawling is continued on the website containing the identified web page (524) immediately, or in parallel with the crawling of other web pages. Alternatively, the website containing the identified web page may be queued for crawling later in the scan or crawling process.

When the execution of the script code is unsuccessful, a failure result is output by the script URL resolution component 340 (530). The failure result is also returned to the website crawler 320. In the website crawler 320, the error result is logged (532), and the crawling of the current website is continued (534).

The process is repeated until crawling of the original website is completed.

The failure results logged at step 532 may be presented to users during and/or after the scanning.

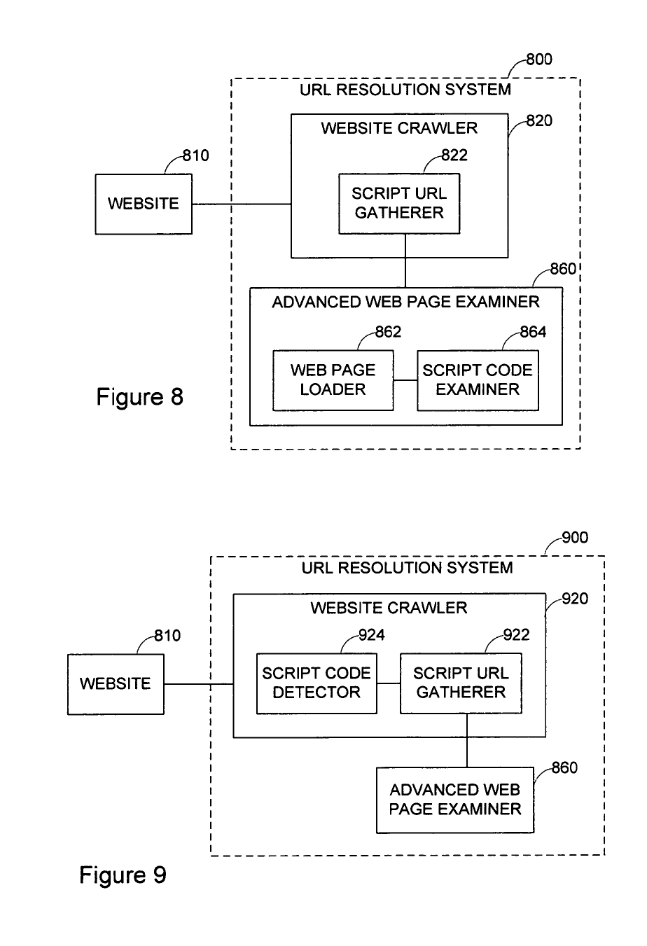

Referring now to FIG. 8, a URL resolution system 800 in accordance with another embodiment of the invention is described. The URL resolution system 800 comprises a website crawler 820 and an advanced web page examiner 860.

The website crawler 820 has a script URL gatherer 822 for gathering script URLs from the advanced web page examiner 860. The advanced web page examiner 860 has a web page loader 862 for loading web pages, and a script code examiner 864 for executing script code in the loaded web pages. The advanced web page examiner 860 may be a part of the URL resolution system 800 or a component external to the system 800.

In operation, the website crawler 820 crawls a website 810. For each URL found on each of those web pages, the script URL gatherer 822 calls a function on the advanced web page examiner 860. It also calls the function for the URL of each web page on which the website crawler 820 crawls. The function takes the received URL as an input parameter and activates the web page loader 862 to load the contents of a web page identified by the received URL.

Then the function activates the script code examiner 864 to examine the loaded web page to obtain any script URLs created by script code in the web page. For example, during the examination of the loaded web page, the script code examiner 864 executes script code found in the loaded web page to obtain script URLs if any. The script code examiner 864 may execute all script code in the loaded web page or only script code that is used to create one or more script URLs. Also, the script code examiner 864 may execute the entire script code or only relevant portions of script code.

The function returns a collection of zero or more resolved script URLs as an output parameter to the script URL gatherer 822. The website crawler 820 may crawl web pages identified by the resolved script URLs. The crawling of those web pages may be carried out immediately or later. The website crawler 820 may crawl those pages in parallel with other web pages.

The website crawler 820 may have a crawling controller similar to crawling controller 324 shown in FIG. 4. Also, the URL resolution system 800 may have or use a presentation unit similar to FIG. 4 or 5.

FIG. 9 shows a modification of the URL resolution system 800 shown in FIG. 8. In the modified URL resolution system 900, the website crawler 920 has a script code detector 924. Similarly to the script code detector 322 shown in FIG. 4, the script code detector 924 checks if a web page contains script code that generates one or more script URLs. By using the script code detector 924, the website crawler 920 passes to the advanced web page examiner 860 only URLs of web pages that contain script code that generates one or more script URLs.

The advanced web page examiner 860 may be a part of the URL resolution system 900 or a component external to the system 900.

In the embodiments shown in FIGS. 4-9, the relevant parts of script code are explicitly executed to obtain script URLs. However, as described referring to FIG. 3, script URLs may be obtained by examining script code, without explicit execution of the script code.

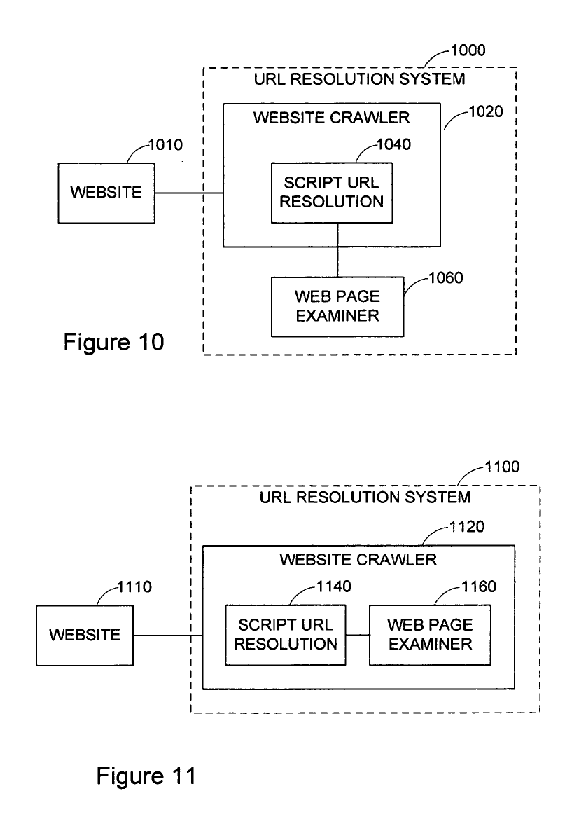

In the above embodiments, the elements of the URL resolution system are described separately, however, two or more elements may be provided as a single element, or one or more elements may be shared with other components in a computer system in which the URL resolution system is installed. For example, in the embodiment shown in FIG. 2, the website crawler 120 and script URL resolution component 140 are shown as separate components. However, as shown in FIG. 10, a URL resolution system 1000 may have a script URL resolution component 1040 as a part of website crawler 1020. A web page examiner 1060 may be a part of the URL resolution system 1000, or a separate component external to the system 1000. Furthermore, as shown in FIG. 11, a URL resolution system 1100 may have a script URL resolution component 1140 and a web page examiner 1160 as components of website crawler 1120. Similar modifications may be made to the embodiments shown in FIGS. 4 and 5.

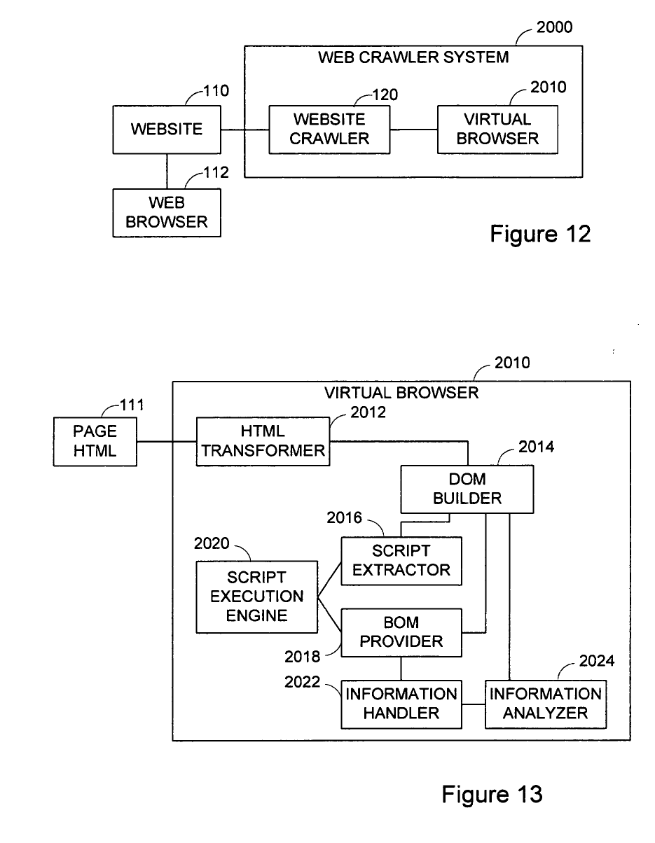

FIG. 12 shows a web crawler system 2000 in accordance with another embodiment of the invention. The web crawler system 200 has an automated website crawler 120 and a virtual browser 2010. The website crawler 120 is similar to that shown in FIG. 2. It may be similar to the website crawler 320 shown in FIGS. 4 and 5. The virtual browser 2010 replicates script processing capabilities of a typical web browser 112 that users use to access websites 110, as further described below.

The web crawler system 2000 allows the automated web crawler 120 to find script related information generated by execution of scripts embedded in web pages. The script related information may be URLs generated by scripts, HTML content generated by scripts, cookies generated by scripts, and/or HTTP requests initiated by scripts, and/or other information associated with the information generated by script execution.

The web crawler system 2000 is described further using JavaScripts embedded in web pages. A different embodiment may be applied to different scripts.

As shown in FIG. 13, the virtual browser 2010 has an HTML transformer 2012, a Document Object Model (DOM) builder 2014, a script extractor 2016, a Browser Object Model (BOM) provider 2018, a script execution engine 2020, and an information handler 2022. The virtual browser 2010 may also have an information analyzer 2024.

The HTML transformation 2012 provides HTML to XML transformation. The web page contains one or more HTML documents. Each HTML document may contain one or more scripts. Scripts in HTML documents are typically written in JavaScript or similar script language. In order for JavaScripts to be provided programmatic access to elements of an HTML document, the virtual browser 2010 parses each HTML document into a tree structure, as is done by a web browser 112. To simplify the parsing process, the virtual browser 2010 uses the HTML transformer 2012 to transform or convert each HTML document into an XML document. XML documents can be easily parsed into a tree structure.

In order to perform the HTML to XML transformation, the HTML transformer 2012 matches the case of start and end tags, terminates empty elements, closes non-empty elements, resolves tag nesting problems, adds missing quotes around attribute values, removes duplicate attributes, eliminates attributes that have no value, e.g., CHECKED, and provides a value. The HTML transformer 2012 makes script blocks containing unparseable characters contained in an XML data section, e.g., CDATA section, in the XML document. The HTML transformer 2012 also transforms specific characters, such as <, >, &, ″ and ′, within the HTML document into an appropriate XML character entity. For example, the HTML transformer 2012 transforms &nbsp; to &#160;.

In order to resolve tag nesting problems to create a tree structure, the HTML transformer 2012 may use heuristic algorithms or processes used by an existing web browser, e.g., heuristic algorithms from a Mozilla web browser. By using these heuristics, the HTML transformer 2012 can convert HTML documents to XML documents in a manner that simulates a web browser's handling of these issues.

The result of the HTML to XML transformation is an in-memory object that represents the HTML page as an XML document object. A single HTML page is typically represented as a single XML document object. HTML pages containing multiple documents (framesets) may be represented as a single XML document object or as a set of XML document objects. The DOM builder 2014 builds a DOM based on the XML document object. The DOM has a tree structure representing how elements or objects in the HTML web page, such as text, images, headers and links, are represented by the XML document object. The DOM also defines what attributes are associated with each object, and how the objects and attributes can be manipulated.

The DOM builder 2014 builds the DOM so that the resultant XML document object is capable of being queried to find executable scripts, and queried during the execution of scripts for data as required. Also, the XML document object is capable of being updated by the execution of scripts, so that it may be dynamically modified by the execution of scripts.

The DOM builder 2014 may also provide the DOM to the information analyzer 2024 so that the XML document object is made available to other parts of the automated crawler 120 for further analysis which are unrelated to JavaScript execution.

The script extractor 2016 identifies and extracts a relevant script or scripts from the DOM.

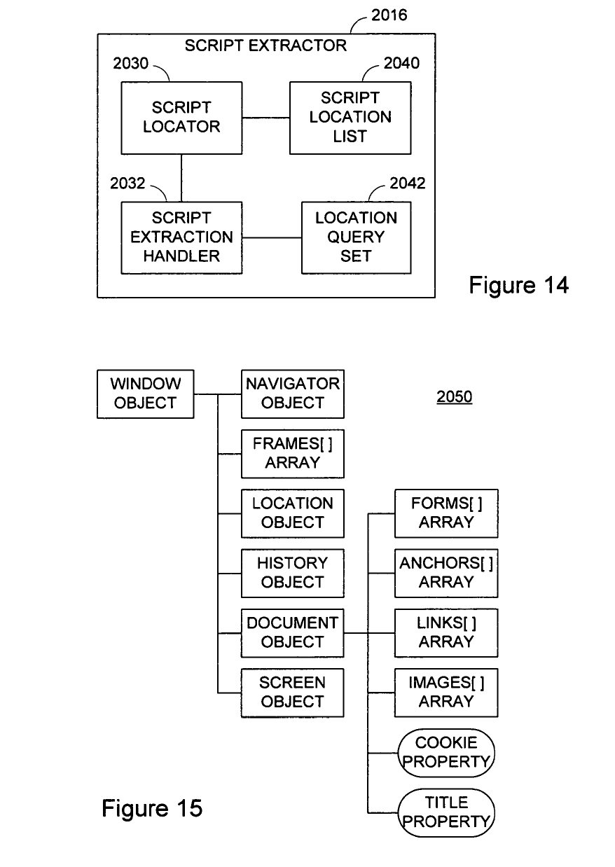

As shown in FIG. 14, the script extractor 2016 has a script locator 2030, an script extraction handler 2032, a script location list 2040, and a location query set 2042.

The script location list 2040 is a list of potential locations for a script to reside in a DOM. For instance, the list includes scripts related with specified tags, such as inline scripts contained inside SCRIPT tags and scripts contained in separate files included using SCRIPT or LINK tags, and various event handlers, such as onclick, onchange, onmouseover event handlers.

The location query set 2042 is a set of location queries that permit the extraction of script contained in event handlers. Location queries are typically XPath queries that identify and extract XML elements for processing.

Some samples of location queries are:

//*[@onclick or @ondblclick or @onmousedown or @onmouseenter
or @onmouseleave or @onmouseout or @onmouseover or @onmouseup]
//*[@onload]
//script[@event= ‘onclick ’ or @event= ‘ondblclick ’ or @event=
‘onmousedown’ or @event= ‘onmouseenter’ or @event= ‘onmouseleave’
or @event= ‘onmouseout’ or @ event= ‘onmouseover’ or @event=
‘onmouseup’]

The script locator 2030 identifies scripts that could potentially be executed using the script location list 2040.

The script extraction handler 2032 extracts the identified scripts. The mechanism used for extracting script depends on the script location. The script extraction handler 2032 may extract scripts contained in SCRIPT tags and LINK tags as the DOM is built. The script extraction handler 2032 may extract scripts contained in event handlers out of the DOM by performing relevant location queries using the location query set 2042.

The BOM provider 2018 provides a Browser Object Model (BOM) containing objects and methods that can be used by a script as it is executed. The BOM provider 2018 provides an implementation of the BOM that is used by typical web browsers 112.

FIG. 15 shows an example of a typical BOM 2050. The BOM 2050 has a window object at the highest level, representing the virtual browser 2010. The window object has a number of properties, such as status that reflects, and provides access to the browser, methods to perform operations for the browser window, and event firing functions. In this example, subordinate objects of the window object include a navigator object, frames array object, location object, history object, document object and screen object. Subordinate objects of the document object includes forms array, anchors array, links array, and images array. As well as subordinate objects, the document object has several properties such as the cookie property and the title property. The BOM provider 2018 may provide a different BOM, depending on a web browser 112 used by a user.

The BOM provider 2018 also implements interfaces for the BOM objects that are exposed by the virtual browser 2010 to JavaScripts to run the JavaScripts found in a web page effectively. The interface of relevant BOM objects, i.e., its external appearance, provided by the BOM provider 2018 is substantially identical to that of a typical web browser 112 so that the script execution controller 2020 can execute scripts in a substantially same manner as a typical web browser 112 executes the scripts.

The BOM objects implemented by the BOM provider 2018 have different behaviours from those of a typical web browser 112. A web browser 112 provides various functions. Thus, the BOM objects of such a web browser 112 provide various behaviours, some of which may be irrelevant or undesirable for performing web crawling. The BOM objects implemented by the BOM provider 2018 of the virtual browser 2010 provide a means for capturing information that are generated by scripts. The BOM objects implemented by the BOM provider 2018 of the virtual browser 2010 also provide a means for the script to retrieve information contained in the DOM and a means for adding or modifying information in the DOM. Also implemented by the BOM provider 2018 is the XmlHttpRequest object. This object is exposed as part of the BOM in some web browsers and as an additional ActiveX in other web browsers. The BOM objects provided in the virtual browser 2010 do not have behaviours that are irrelevant or undesirable for performing web crawling.

The BOM provider 2018 exposes the BOM into the script execution environment in order to obtain meaningful results when script is executed.

The script execution engine 2020 executes the extracted scripts using the BOM.

The script execution engine 2020 determines entry points for the script execution. For instance, the script execution engine 2020 determines script not enclosed in a function in a script tag, and script in event handlers, as entry points.

The script execution engine 2020 executes each entry point. During the execution, the script execution engine 2020 allows the associated script to make calls into BOM objects, which results in the detection of script related information, such as URLs, HTTP requests, cookies, and/or changes of document content. Changes of document content may be additions, deletions, modifications or retrieval of document content.

The information handler 2022 interfaces with the BOM objects and captures the script related information generated by the script execution.

For instance, a JavaScript that invokes document.cookie calls into the cookie property on the document object, provided as part of the virtual browser 2010 in the BOM. The implementation of the document object in the BOM of the virtual browser 2010 allows the information handler 2022 to capture the name, value and other information of the cookie generated by the script, such that the captured information can be used by the automated web crawler 120.

The script execution engine 2020 also updates the DOM based on the execution of the scripts using the BOM. It is possible for scripts to modify content in the DOM, to delete content in the DOM, or to add new content to the DOM. The BOM provides objects that work closely with objects in the DOM. When a JavaScript calls BOM methods that cause changes in the document content, the BOM provider 2018 interacts with the DOM in order to update the DOM as required. Similarly, if a JavaScript seeks to retrieve information from the DOM by calling a BOM method, the BOM provider 2018 interacts with the DOM in order to return the required information to the script.

The DOM itself provides methods that allow data within the DOM to be retrieved, modified, deleted and added. The BOM also provides methods that allow data within the DOM to be retrieved, modified, deleted, and added. When a BOM method to retrieve, modify, delete or add data to the document is invoked by executing a script, the BOM method calls the corresponding method on the DOM in order to effect the necessary change in the DOM.

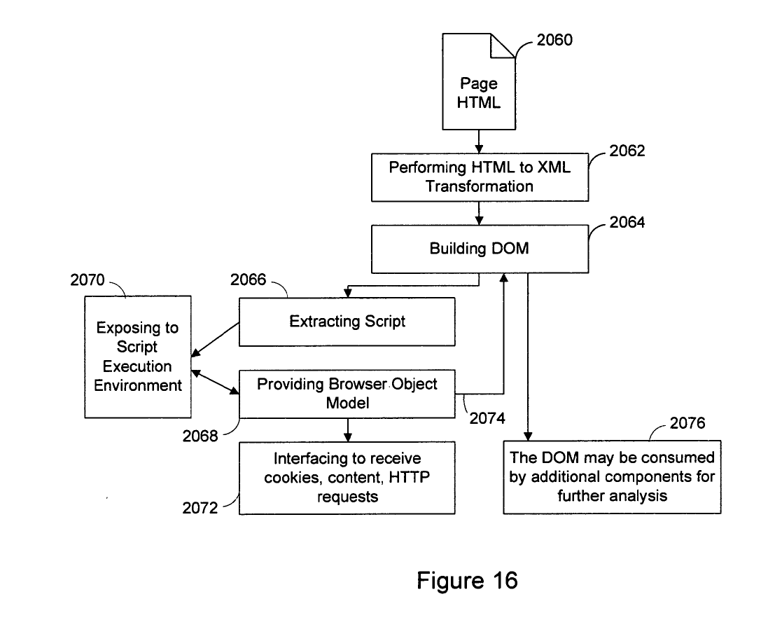

FIG. 16 shows the operation of the virtual browser 2010.

The virtual browser 2010 receives a web page HTML document from the website crawler 120 (2060), and performs HTML to XML transformation to transform the HTML document into an XML document using the HTML transformer 2012 (2062). The DOM builder 2014 of the virtual browser 2010 builds a DOM having a tree structure representing elements of the HTML document using the XML document (2064).

The script extractor 2016 extracts from the DOM one or more scripts that may potentially be executed (2066). The script extraction may be carried out by identifying potentially executable scripts using the script locations list, and extracting the identified scripts as the DOM is built, or by performing one or more location queries, depending on the type of the scripts as described above.

The BOM provider 2018 provides a BOM (2068).

The virtual browser 2010 loads and exposes the extracted scripts into the script execution environment along with the BOM (2070). In the script execution environment, the script execution engine 2020 of the virtual browser 2010 determines entry points and executes each entry point. During the execution, the associated script makes calls into BOM objects that results in the detection of script related information, such as URLs, HTTP requests, cookies, and/or changes of document content.

The virtual browser 2010 interfaces with the BOM objects and captures the name, value and/or other script related information detected during the script execution so that the captured information can be used by the automated web crawler 120 (2072).

The virtual browser 2010 also updates the DOM based on the execution of scripts through the BOM (2074).

The virtual browser 2010 may also make the DOM available to other parts of the automated crawler for further analysis unrelated to JavaScript execution (2076).

Thus, the virtual browser 2010 replicates the script processing capabilities of typical web browsers, and allows automated web crawling without actually navigating through web pages using the web browser 112.

The script extraction (2036) is further described using the following example of a script that may be found in a web page, in which line numbers are added for the convenience of the description:

1 <HTML>
2 <HEAD>
3 </HEAD>
4 <BODY>
5 <SCRIPT>
6 var content = “Some ” + “Dyna” + “mic Content”;
7 document.write(content);
8 </SCRIPT>
9 <SCRIPT>
10 var cookieName = “CookieName”;
11 var cookieValue = 12 * 2;
12 document.cookie = cookieName+“=”+cookieValue.toString( );
13 </SCRIPT>
14 </BODY>
15 </HTML>

The script extractor 2016 has a list 2040 listing possible locations where a script is allowed in an HTML document. For instance, there is an entry in the list 2040 that indicates that a script may be expected to be found inside a <SCRIPT> tag.

Using this entry in the list 2040, the script extractor 2016 extracts the first script in the example, which is:

6 var content = “Some ” + “Dyna” + “mic Content”;
7 document.write(content);

Line 6 can be executed in the JavaScript engine 2020 without any external objects. However, the objective of the virtual browser 2010 is to determine the content that is written to the HTML document. To achieve this objective, the engine 2020 also executes Line 7. Since the JavaScript code was originally written to be executed inside a web browser 112, the script code makes use of the objects and methods provided by a web browser 112 through its BOM. In this case, the script code is written to use the document object and the write method of the BOM of a web browser 112. In order to execute Line 7 successfully, the virtual browser 2010 provides a BOM containing its own version of the document object with a write method. While the behaviour of the document object of the BOM of the virtual browser 2010 differs from the document object of the BOM provided by the browser 112, the interface of the object, i.e., its external appearance, of the virtual browser 2010 is substantially identical to that of the browser 112. Because its interface is substantially identical, the script execution controller 2020 can execute the script. The behaviour of the object is different because the virtual browser 2010 needs simply to capture the content that are generated by the script, rather than actually navigating to the related web page by the browser 112. Actual navigation to related web pages by the browser 112 involves various features, such as invocation of pop up windows, which are often irrelevant to web crawling.

Likewise, the script extractor 2016 extracts the second script:

10 var cookieName = “CookieName”;
11 var cookieValue = 12 * 2;
12 document.cookie = cookieName+“=”+cookieValue.toString( );

Lines 10 and 11 can be executed in the JavaScript engine 2020 without any external objects. However, the objective of the virtual browser 2010 is to determine the cookie that is created by this second script. To achieve this objective, the virtual browser 2010 also executes Line 12 in the JavaScript engine 2020. Since this JavaScript code was originally written to be executed inside a web browser 112, it makes use of the objects and methods provided by the web browser 112: in this case the document object and the cookie method. In order to execute Line 12 successfully, the virtual browser 2010 provides its own version of the document object with a cookie method. While the behaviour of the document object provided by the virtual browser 2010 differs from the document object provided by the browser 112, the interface of the object provided by the virtual browser 2010 is substantially identical to that provided by the browser 112. Since the interface is substantially identical, the script execution engine 2020 can execute the script. The BOM object of the virtual browser 2010 provides the behaviour simply to capture the cookie that has been generated by the script.

Likewise, for scripts that make use of objects to initiate HTTP requests, the virtual browser 2010 provide BOM objects that allow the information handler 2022 to intercept the request URLs. The interception of the request URLs is described using the following example of JavaScript, in which line numbers are added for convenience of description:

| 1. | <SCRIPT> |
|---|---|
| 2. | var req; |
| 3. | |
| 4.function loadXMLDoc(url) { | |
| 5. | req = false; |
| 6. | // branch for native XMLHttpRequest object |
| 7. | if(window.XMLHttpRequest) { |
| 8. | try { |
| 9. | req = new XMLHttpRequest( ); |
| 10. | } catch(e) { |
| 11. | req = false; |
| 12. | } |
| 13. | // branch for IE/Windows ActiveX version |
| 14. | } else if(window.ActiveXObject) { |
| 15. | try { |
| 16. | req = new ActiveXObject(“Msxml2.XMLHTTP”); |
| 17. | } catch(e) { |
| 18. | try { |
| 19. | req = new ActiveXObject(“Microsoft.XMLHTTP”); |
| 20. | } catch(e) { |
| 21. | req = false; |
| 22. | } |
| 23. | } |
| 24. | } |
| 25. | if(req) { |
| 26. | req.onreadystatechange = processReqChange; |
| 27. | req.open(“GET”, url, true); |
| 28. | req.send(“”); |
| 29. | } |
| 30. | |
| 31. | |
| 32. | var watchfireUrl = “http://www.” + “Watchfire.com”; |
| 33. | loadXMLDoc(watchfireUrl); |
| 34. | }</SCRIPT> |

In order to capture the URL of an HTTP request initiated from the JavaScript, the virtual browser 2010 provides BOM objects that replicate the external interfaces of the XMLHttpRequest object. The following three lines in this example create a similar object that is used by the script to initiate HTTP request from the scripts:

| | |
|---|---|
| 9. | req = new XMLHttpRequest( ); |
| 16. | req = new ActiveXObject(“Msxml2.XMLHTTP”); |
| 19. | req = new ActiveXObject(“Microsoft.XMLHTTP”); |

The scripts are written this way to provide compatibility with multiple web browsers.

In order to execute this script without errors and to eventually obtain the correct URL for the HTTP request, the virtual browser 2010 provides a replica or facsimile of the object expected to be created by the scripts contained in Lines 9, 16 and 19. The virtual browser 2010 provides, for Line 9, a BOM object that has the substantially same interface as XMLHttpRequest, so that the script execution engine 2020 can execute the JavaScript. The behaviour of the BOM object representing XMLHttpRequest implemented by the virtual browser 2010 is not to initiate a request, but rather to capture the URL provided in the call to the open method on Line 27:

27. req.open(“GET”, url, true);

As described above, the virtual browser 2010 allows the automated web crawler 120 to more accurately simulate the navigation behaviour of a human user using a web browser 112 to navigate a web site. The virtual browser 2010 allows the content that is created by scripts to be discovered. The automated web crawler 120 is able to perform the same analyses on this “dynamic content” as is applied to traditional “static content”. The virtual browser 2010 also allows cookies that are created by scripts to be discovered. The automated web crawler 120 is able to perform the standard analyses on these discovered cookies. The automated web crawler 120 is able to send these cookies with future HTTP requests in order to improve the automated web crawl. The virtual browser 2010 also allows HTTP requests initiated by scripts to be detected. Web applications broadly referred to as “AJAX applications” use JavaScripts to initiate HTTP requests in order to update state on the web server and to obtain updated data. The virtual browser 2010 allows the automated web crawler 120 to discover these HTTP requests in order to simulate, within an automated web crawler 120, the content and behaviour of an “AJAX” web application.

The web crawler system and virtual browser of the present invention may be implemented by any hardware, software or a combination of hardware and software having the above described functions. The software code, either in its entirety or a part thereof, may be stored in computer readable memory. Further, a computer data signal representing the software code which may be embedded in a carrier wave may be transmitted via a communication network. Such a computer readable memory, a computer data signal and a carrier wave are also within the scope of the present invention, as well as the hardware, software and the combination thereof.

While particular embodiments of the present invention have been shown and described, changes and modifications may be made to such embodiments without departing from the true scope of the invention.

1-23. (canceled)

24. A URL resolution system for resolving Universal Resource Locators (URLs), the URL resolution system comprising at least one computer coupled to at least one other computer that provides a web page having script that dynamically creates one or more script URLs, the at least one computer comprising:
a website crawler that crawls the website and that locates script code which is used to dynamically create at least one script URL; and
a script URL resolution component that causes the at least one computer to examine the script code located during the crawling and to execute the script code to obtain the script URL.

25. The URL resolution system as claimed in claim 24 wherein the website includes one or more web pages, and
the website crawler crawls individual web pages associated with websites, and has a crawling controller for controlling the website crawler.

26. The URL resolution system as claimed in claim 25 wherein the website crawler has a script code detector for determining if a web page uses script code to dynamically create at least one script URL.

27. The URL resolution system as claimed in claim 26 wherein the script code detector has a notification generating function for generating a notification when the script code detector locates a web page that uses script code to dynamically create at least one script URL.

28. The URL resolution system as claimed in claim 25 wherein the crawling controller receives results of script code examination from the script URL resolution component, and controls the website crawler based on the examination results.

29. The URL resolution system as claimed in claim 24 wherein the website includes one or more web pages, the script code has a specific part that is used to create the script URL, and the script URL resolution component comprises:
a web page loading controller that instructs a web page examiner to load the web page located by the website crawler;
a script code execution controller that instructs the web page examiner to execute the specific part of the script code used in the loaded web page to obtain the script URL and that passes to the web crawler component script created information, including the script URL, that crawls the script created information, the script created information further comprising at least one of: HTML content generated by scripts, cookies generated by scripts, HTTP requests initiated by scripts, and document content generated by script execution.

30. A method for resolving Universal Resource Locators (URLs), the method comprising steps of:
locating, using at least one computer coupled to at least one other computer that provides a web page having script that dynamically creates one or more script URLs, script code which creates at least one script URL while crawling a website;
examining and executing the script code to obtain the script URL from the examination result by executing the script code.

31. The method as claimed in claim 30 wherein a website has one or more web pages;
the locating step locates a web page that uses script code to dynamically create at least one script URL, the script code having a specific part that is used for the creation of the script URL; and
the examination step comprises steps of:
loading the located web page;
executing the specific part of the script code in the loaded web page to resolve the script URL; and
crawling the script URL and at least one of: HTML content generated by scripts, cookies generated by scripts, HTTP requests initiated by scripts, and document content generated by script execution.

32. The method as claimed in claim 31 further comprising a step of continuing crawling of a web page identified by the script URL.

33. The method as claimed in claim 30 further comprising steps of:
obtaining examination results including the script URL when the examination step is successful and a failure result when the examination step fails to obtain the script URL; and
presenting to a user the examination result including the script URL and/or the failure result.
